(19) United States
(12) Patent Application Publication
(10) Pub. No.: US 2003/0042721 A1
(43) Pub. Date: Mar. 6, 2003

(54) Safety system for a motor vehicle

(76) Inventors: Ralf Bocksch, Moosburg (DE); Peter Faulhaber, Munchen (DE); Michael Grunewald, Hohenkirchen (DE); Clark Rudebusch, Renningen (DE)

Correspondence Address: KENYON & KENYON, ONE BROADWAY, NEW YORK, NY, 10004, US

(21) Appl. No.: 10/224,673

(22) Filed: Aug. 20, 2002

(30) Foreign Application Priority Data
Aug. 29, 2001 (DE) 101 42 168.0

(51) Int. Cl. B60R 21/26

(52) U.S. Cl. 280/742

(57) ABSTRACT

In order to provide a safety system for a motor vehicle having a gas generator for producing a gas flow, at least one gas outlet opening formed in the gas generator and at least one restraining arrangement associated with the gas generator, which system may provide better comfort for vehicle occupants during production of the gas while retaining those properties of conventional systems that are relevant from a safety point of view, the safety system includes an arrangement for enhancing comfort which is associated with the gas outlet opening and influence, in particular damp, a frequency profile generated during the emergence of the gas.

### CROSS-REFERENCE TO RELATED APPLICATIONS

The present application claims priority to Application No. 101 42 168.0, filed in the Federal Republic of Germany on Aug. 29, 2001, which is expressly incorporated herein in its entirety by reference thereto.

### FIELD OF THE INVENTION

The present invention relates to a safety system for a motor vehicle having a gas generator for producing a gas flow, at least one gas outlet opening formed in the gas generator, and at least one restraining means associated with the gas generator.

### BACKGROUND INFORMATION

Safety systems of this kind are conventional. With conventional systems, however, the comfort of vehicle occupants can be impaired if the attendant circumstances are unfavorable, due to the outflow of gas and the associated production of sound.

Given this situation, it is an object of the present invention to provide a safety system for a motor vehicle having a gas generator for producing a gas flow, at least one gas outlet opening formed in the gas generator and at least one restraining arrangement associated with the gas generator, which system may provide better comfort for vehicle occupants during production of the gas while retaining those properties of conventional systems that are relevant from a safety point of view.

### SUMMARY

The above and other beneficial objects are achieved by providing a safety system as described herein.

According to the present invention, in addition to a gas generator with at least one opening and at least one restraining arrangement, an arrangement for enhancing comfort is provided, which influence, in particular damp, a frequency profile generated during the emergence of the gas. As a result, the frequency profile of the entire sound event is influenced and it may be ensured that appropriate comfort is provided for vehicle occupants, despite the activation of the safety system according to the present invention. The sound generated is damped, at least in partial ranges, and any unpleasant noise generation may thus be prevented. Troublesome medium- and higher-frequency components of the noise associated with gas production, in particular, may be reduced with the solution according to the present invention.

According to one example embodiment of the present invention, the arrangement for enhancing comfort at least partially reflects the sound generated during the production of a gas flow. This makes it possible to ensure that the sound generated during gas production does not move directly from the gas generator to vehicle occupants but first of all moves in another appropriate direction. This diversion or screening may contribute to reducing sound peaks.

It is also possible for the arrangement for enhancing comfort to at least partially absorb the sound. Through absorption of sound waves, it is possible to attenuate the sound pressure overall and hence contribute to enhancing comfort. Diffraction and refraction of the sound waves are also possible.

The arrangement for enhancing comfort may be of plate-shaped configuration. Such plate-shaped structures may be suitable for guiding sound waves in a particular direction. It is possible to provide a plate arranged between the gas outlet opening and the occupant.

However, the arrangement may also be of duct-shaped configuration and be arranged so that an opening of the duct-shaped arrangement is arranged in front of the gas outlet opening of the gas generator. In this manner, the pressure generated is guided directly into the duct-shaped arrangement.

If the arrangement furthermore includes an angle, the sound waves generated may be guided in an appropriate direction for minimum disturbance to an occupant. It is also possible for a plurality of angles to be provided, giving rise to a kind of meandering extension of the outlet opening.

The arrangement may include a sound-reflecting media or of sound-absorbing media. It is also possible for a combination of the two materials to be provided. Depending on the arrangement of the materials on the comfort enhancement arrangement, a very specific proportion of damping for sound pressure peaks may be achieved. It is possible to select the materials so that they reflect or absorb one frequency range particularly well. This may increases the effectiveness of the arrangement for enhancing comfort.

According to another example embodiment of the present invention, the arrangement for enhancing comfort includes at least one Helmholtz resonator. A Helmholtz resonator of this kind has a particular air volume. This air volume is excited by sound waves. The movement of the air is intensified by resonance. This gives rise to friction, which, in turn, generates heat. The Helmholtz resonator accordingly absorbs sound waves and converts them into heat. The frequency range of the Helmholtz resonator may be tuned to a particular frequency spectrum which arises during the production of a gas flow. In this manner, it is possible to absorb particularly troublesome frequency ranges, for example.

The arrangement for enhancing comfort may each be associated with one gas outlet opening of the gas generator. This enables the sound waves to be intercepted directly at their point of origin before they propagate within the interior of the vehicle. Where there is a plurality of gas outlet openings, it is accordingly also possible for a plurality of arrangements for enhancing comfort to be provided.

According to another example embodiment of the present invention, the arrangement for enhancing comfort may include a layer applied to the inside of an airbag to be expanded by the gas flow produced. In this context, the word “inside” is intended to mean that side of the airbag which faces the gas generator. This layer may include sound-absorbing material. It is also possible to make the airbag itself of absorbing material. By virtue of this arrangement, some of the sound pressure peaks are absorbed in the airbag and are prevented from penetrating into the interior of the vehicle.

The frequency profile may additionally be influenced by configuring the outlet opening in the gas generator in a manner that is favorable in terms of flow. Thus, for example, the edges may be adapted so as to minimize noises caused by the flow.

If a duct is provided as an outflow opening, the cross-section of the outflow duct may be varied along its length. The changes in cross-section alter the flow velocity and pressure of the gas. Due to the relationship of dependence between the speed of sound and the pressure of the propagation medium, the sound event is affected. There may be several changes in cross-section in the outflow duct.

If there is a plurality of openings in the gas generator, they may have different shapes, for example. The distance between the individual openings may also be adapted. The overall sound event is influenced by interference effects. There may be superposition (in the best case elimination) of the noise generated by the individual outflow openings.

The safety system according to the present invention may be equipped with all retaining arrangements which are activated by a suddenly arising gas flow. Airbag and belt systems of all types may be mentioned here by way of example. The present invention may furthermore be used with all gas generation systems, e.g., with hybrid or pyrotechnic gas generation systems.

The present invention is explained in greater detail below with reference to the exemplary embodiments illustrated in the Figures.

### BRIEF DESCRIPTION OF THE DRAWINGS

FIG. 1 is a schematic view of a safety system according to the present invention with a plate-shaped arrangement for enhancing comfort.

FIG. 2 is a schematic view of a safety system according to the present invention with a tubular arrangement for enhancing comfort.

FIG. 3 is a schematic view of a safety system according to the present invention with a Helmholtz resonator as an arrangement for enhancing comfort.

FIG. 4 is a schematic view of a safety system according to the present invention with an airbag and arrangement provided on the airbag for enhancing comfort.

### DETAILED DESCRIPTION

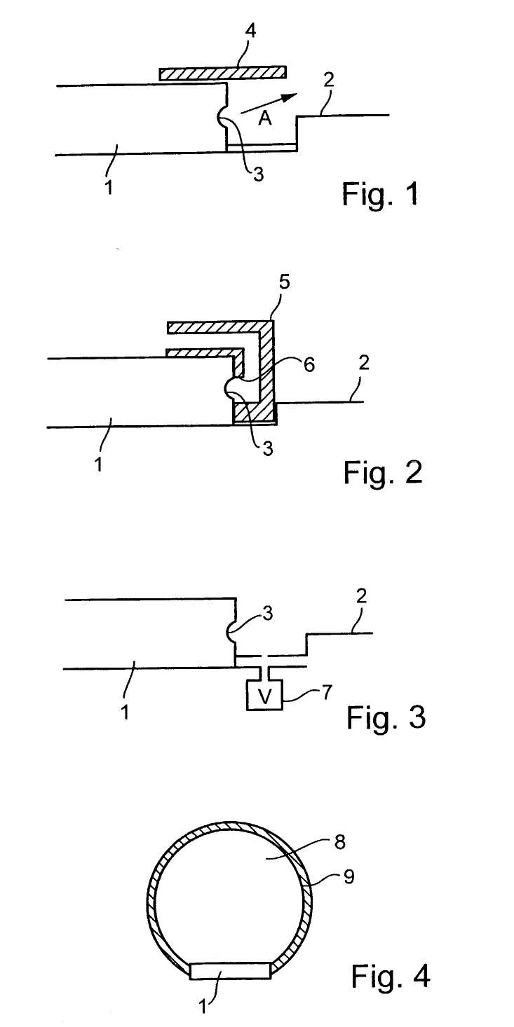

FIG. 1 illustrates a gas generator 1, which is used to produce a gas flow. A gas flow of this kind may be used to activate restraining device. For example, an airbag may be filled or mechanical elements set in motion by a gas flow of this kind. This gas generator 1 is held in a position fixed relative to the vehicle by suitable fixing arrangement 2. An opening 3, through which the gas flow produced may escape, is formed in the gas generator 1. The gas outlet direction is indicated by the arrow A.

A plate 4 is arranged on the gas generator 1. It may be fixed on the gas generator 1 by a conventional fixing element. In the exemplary embodiment illustrated, the plate 4 is arranged at a certain angle relative to the gas outlet direction A. This angle may be used to adjust how many of the sound waves generated, which do not necessarily propagate in accordance with the gas outlet direction A, will be reflected. The plate 4 may include a material which reflects sound waves particularly well. However, it may also be composed of a material which absorbs sound waves particularly well. However, a mixture of the two options is also possible. For example, an additional absorbing layer—including a mesh and/or foam—may be applied on the side of the plate 4 facing the opening of the gas generator 1. The closer the plate 4 is mounted to the gas generator 1, the more effective is the screening of the sound waves.

FIG. 2 illustrates another example embodiment of the safety system according to the present invention. This differs from that described above only in that the arrangement 5 for enhancing comfort has a duct-shaped configuration. An opening 6 of the duct 5 is associated with the gas outlet opening 3 of the gas generator 1. The sound waves generated during the production of the gas flow are thus guided directly into the duct 5 and initially propagate in the latter. The walls of the duct 5 are aligned with a sound-absorbing material. Due to its surface configuration, this has an actively damping surface. The duct 5 allows the gas flow to emerge unhindered and, due to its energy-absorbing properties, furthermore attenuates at least some of the sound pressure generated. The internal lining of the duct 5 may be composed of foam, e.g., foamed metal, or of a mesh, for example.

FIG. 3 illustrates other arrangements for enhancing comfort. They include a Helmholtz resonator 7, which is arranged close to the gas outlet opening 3. The Helmholtz resonator encloses a certain gas volume V, which is excited by the sound waves generated during the production of the gas flow. In a certain frequency range, the sound waves are amplified in the volume by resonance. As a result, there is increased excitation of the gas volume and, owing to the friction generated, heat is released. The resonator thus converts sound waves in a certain frequency range into heat. Due to the conversion, this frequency range is accordingly damped, contributing to the damping of sound-pressure peaks and ensuring a certain comfort.

In FIG. 4, an airbag 8 is illustrated schematically in a deployed state with a gas generator 1. The airbag 8 is distinguished by the fact that a layer 9 is applied to its inside, i.e., on its side facing the gas generator. This layer is composed of a sound-absorbing material. Felt mats, foam, metal foil or mineral fibers may be used for this purpose, for example. However, it is also possible for the airbag itself to be composed of this material.

An important factor with all media arranged in the immediate vicinity of the gas generator may be their heat resistance. During the production of the gas flow, heat is released, and these media may withstand this heat in order to take effect. All the comfort-enhancing arrangements described may also be provided in combination with one another. It is, for example, possible to provide a gas generator with a Helmholtz resonator and, at the same time, with a plate-shaped screening element.

What is claimed is:

1. A safety system for a motor vehicle, comprising:
a gas generator configured to produce a gas flow;
at least one gas outlet opening arranged in the gas generator;
at least one restraining arrangement associated with the gas generator; and
an arrangement configured to enhance comfort associated with the gas outlet opening and configured to influence a frequency profile generated during emergence of gas.

2. The safety system according to claim 1, wherein the comfort enhancement arrangement is configured to at least partially reflect sound generated.

3. The safety system according to claim 1, wherein the comfort enhancement arrangement is configured to at least partially absorb sound generated.

4. The safety system according to claim 1, wherein the comfort enhancement arrangement includes a plate-shaped configuration.

5. The safety system according to claim 1, wherein the comfort enhancement arrangement includes a duct-shaped configuration.

6. The safety system according to claim 5, wherein the duct-shaped comfort enhancement arrangement includes at least one angle.

7. The safety system according to claim 4, wherein the comfort enhancement arrangement is arranged at a specific angle to an outlet direction of the gas flow.

8. The safety system according to claim 4, wherein the comfort enhancement arrangement is composed at least partially of sound-reflecting materials.

9. The safety system according to claim 4, wherein the comfort enhancement arrangement is composed at least partially of sound-absorbing materials.

10. The safety system according to claim 1, wherein the comfort enhancement arrangement includes at least one Helmholtz resonator.

11. The safety system according to claim 1, wherein the comfort enhancement arrangement is tuned to a frequency spectrum of sound generated during production of the gas flow.

12. The safety system according to claim 1, further comprising an arrangement configured to reduce sound generated during production of the gas flow is associated with each gas outlet opening.

13. The safety system according to claim 1, wherein the comfort enhancement arrangement includes a layer arranged on a side of an airbag that faces the gas generator.

14. The safety system according to claim 13, wherein the layer includes a sound-absorbing material.

15. The safety system according to claim 1, wherein the restraining arrangement includes an airbag made of an energy-absorbing material.

16. A safety system for a motor vehicle, comprising:
a gas generator for producing a gas flow;
at least one gas outlet opening formed in the gas generator;
at least one restraining means associated with the gas generator; and
means for enhancing comfort associated with the gas outlet opening and influence a frequency profile generated during the emergence of the gas.

17. The safety system according to claim 16, wherein the comfort enhancing means at least partially reflects the sound generated.

18. The safety system according to claim 16, wherein the comfort enhancing means at least partially absorbs the sound generated.

19. The safety system according to claim 16, wherein the comfort enhancing means includes a plate-shaped configuration.

20. The safety system according to claim 16, wherein the comfort enhancing means includes a duct-shaped configuration.

21. The safety system according to claim 20, wherein the duct-shaped comfort enhancing means includes at least one angle.

22. The safety system according to claim 19, wherein the comfort enhancing means is arranged at a specific angle to an outlet direction of the gas flow.

23. The safety system according to claim 19, wherein the comfort enhancing means is composed at least partially of sound-reflecting materials.

24. The safety system according to claim 19, wherein the comfort enhancing means is composed at least partially of sound-absorbing materials.

25. The safety system according to claim 16, wherein the comfort enhancing means includes at least one Helmholtz resonator.

26. The safety system according to claim 16, wherein the comfort enhancing means is tuned to a frequency spectrum of sound generated during production of the gas flow.

27. The safety system according to claim 16, further comprising means for reducing sound generated during production of the gas flow associated with each gas outlet opening.

28. The safety system according to claim 16, wherein the comfort enhancing means includes a layer arranged on a side of an airbag that faces the gas generator.

29. The safety system according to claim 28, wherein the layer includes a sound-absorbing material.

30. The safety system according to claim 16, wherein the restraining means includes an airbag made of energy-absorbing material.
